(19) United States
(12) Patent Application Publication
(10) Pub. No.: US 2011/0295688 A1
(43) Pub. Date: Dec. 1, 2011

(54) DEFINING USER INTENT

(75) Inventors: Dou SHEN, Bellevue, WA (US); Michael ELIZAROV, Sammamish, WA (US); Ying LI, Bellevue, WA (US); Valeri LIBORSKI, Bellevue, WA (US); Teresa B. MAH, Bellevue, WA (US); Ismail PARSA, Bellevue, WA (US)

(73) Assignee: MICROSOFT CORPORATION, REDMOND, WA (US)

(21) Appl. No.: 12/790,523

(22) Filed: May 28, 2010

(51) Int. Cl. G06F 17/30; G06Q 30/00

(52) U.S. Cl. 705/14.54; 705/14.53; 707/803; 707/769; 707/722; 707/E17.044; 707/E17.014

(57) ABSTRACT

Methods and computer-readable media are provided for defining user intent so that user intent can be determined and advertisements and other information can be provided to a user based on that user's intent. A topical expression is identified and is associated with attributes and actions. Actions indicate steps that can be performed to achieve a task associated with the topical expression. An intent structure is then generated. The intent structure illustrates a relationship between the identified topical expression and other topical expressions. User data may then be received and mapped to the intent structures to determine present and future user intent.

### BACKGROUND

Traditionally, advertisements and other information sources are identified as being relevant to a user based on the user's current behavior, including search queries and page-views, without consideration of the user's intent in a richer context. This approach rarely provides the user with relevant information, as it fails to take into consideration other sources of user information other than the user's current behavior. For instance, when a user submits a query on a search page, in most cases, it is difficult to determine the user's true need or intent based on a single query. The query “Chicago,” for example, has multiple meanings, including a city, a band, and a movie. Even if it is known that the user is referring to the city, the user's true intent is still unknown. For instance, the user may want to travel to Chicago, move to Chicago, find out about current weather conditions in Chicago, may simply want general information about Chicago, or the like.

Further, a future intent of the user typically cannot be determined by solely analyzing the user's current behavior. As an additional example, the search query “camera” may represent a multitude of intents that the user may have in relation to a camera, such as purchasing, selling, reading reviews, repairing, and so on. Providing search results based only on the search query “camera” results in a frustrating user experience, because without knowing more about the user's intent, the user is oftentimes not directed to relevant information.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to methods for defining and determining user intent based on user information received from various sources. A factor for online service is understanding user intent. Relevant services cannot be provided to online users without understanding the users' true needs. As such, embodiments of the present invention provide a definition of a scientific approach to represent user intent. User intent can be defined by three aspects: semantics, preferences, and pragmatics, based on which the users can then achieve their goals in a more timely and efficient manner. The semantics portion of intent indicates what the intent is actually about, such as in a topical sense. As such, a topical expression represents the semantics of intent. The preference portion of intent (e.g., attributes) indicates a user's preference for a particular topical expression. Finally, the pragmatic portion of intent indicates a task or action that the user has in mind in relation to the topical expression. Stated differently, the pragmatic portion of the intent definition defines the steps and activities that can be performed to achieve a task. The topical expressions, along with associated attributes and actions are represented in an intent structure, which illustrates relationships between various topical expressions. An algorithm is then used to map keywords from user data to the intent structures to infer current and future user intent. Various types of information, such as advertisements and search results, may be provided to the user based on the inferred user intent.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary computing system architecture configured for use in implementing embodiments of the present invention;

FIG. 3 is a block diagram of an exemplary system for advertising based on a defined user intent, in accordance with embodiments of the present invention;

FIG. 4 is a diagram illustrating three aspects used to define user intent, in accordance with an embodiment of the present invention;

FIG. 5 is a hierarchical tree used to define intent taxonomy, in accordance with an embodiment of the present invention;

FIG. 6 is a table illustrating a hierarchical structure of topics, in accordance with an embodiment of the present invention;

FIG. 7 is a table listing exemplary actions associated with a particular topic, in accordance with an embodiment of the present invention;

FIG. 8 is a table listing exemplary attributes associated with a particular topic, in accordance with an embodiment of the present invention;

FIG. 9 is a flow diagram of a method for defining user intent, in accordance with embodiments of the present invention; and

FIG. 10 is a flow diagram of a method for representing user intent, in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide for a method to define user intent so that current and future user intent can be inferred and used to select and provide relevant advertisements and other such information to the user. Initially, user intent is defined by three aspects, including semantics, preferences, and pragmatics. Accordingly, three-way diagrams are generated that include a particular semantic (e.g., topical expression), one or more pragmatics (e.g., actions), and optionally, one or more preferences (e.g., attributes). As such, in one embodiment, attributes are not associated with the particular topical expression. From these three-way diagrams, hierarchical tree structures are generated that demonstrate relationships between various topics, also referred to herein as topical expressions. For instance, a first topical expression “vehicle” may include several subtopical expressions, such as “motorcycle,” “SUV,” and “compact sedan.” Exemplary actions for “vehicle” include “service,” “auto,” and “dealership.” Exemplary attributes for “vehicle” include “fuel type” and “cost.” Once the hierarchical structures are generated, user intent is inferred by way of an algorithm that matches keywords found in user data (e.g., log data, user profile, social networking sites) with terms in the hierarchical structures. From there, advertisements and other information sources, such as search results, a series of steps used to perform a task, and personalization of a website, can be provided to the user based on the user's intent.

Accordingly, in one aspect, the present invention is directed to one or more computer-readable media storing computer-useable instructions that, when used by one or more computing devices, cause the one or more computing devices to perform a method. The method includes identifying a topical expression, and associating at least one action with the topical expression, wherein the at least one action indicates a step to be performed to achieve a task corresponding to the topical expression. The method additionally includes generating an intent structure that indicates a relationship between the topical expression and one or more other topical expressions.

In another aspect, the present invention is directed to one or more computer-readable media storing computer-useable instructions that, when used by one or more computing devices, cause the one or more computing devices to perform a method. The method includes a search result modification system. The system includes a computing device associated with one or more processors and one or more computer-readable storage media and a data store coupled with the computing device. Further, the system includes an intent determination engine that defines user intent by associating actions and attributes with topical expressions, organizes the topical expressions to represent relationships between the topical expressions, and determines the user intent for a particular user using the organized topical expressions and user data received from one or more sources.

A further aspect is directed to one or more computer-readable media storing computer-useable instructions that, when used by one or more computing devices, cause the one or more computing devices to perform a method. The method includes associating each of a plurality of topical expressions with at least one attribute and at least one action. The method further includes generating a hierarchical structure that represents relationships between the plurality of topical expressions and receiving user data from one or more sources. Additionally, the method includes algorithmically determining user intent by identifying keywords in the user data that correspond to the plurality of topical expressions, the at least one attribute, and the at least one action in the hierarchical structure.

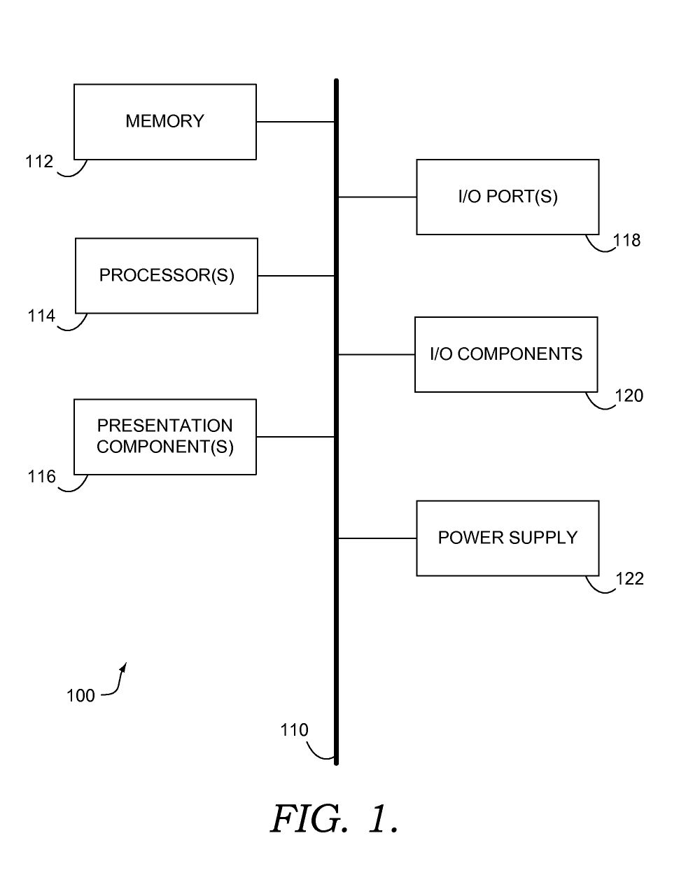

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including handheld devices, consumer electronics, general-purpose computers, more specialty computing devices, and the like. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” and the like, as all are contemplated within the scope of FIG. 1 and reference to “computing device.”

The computing device 100 typically includes a variety of computer-readable media. Computer-readable media can be any available media that can be accessed by computing device 100 and includes both volatile and nonvolatile media, removable and nonremovable media implemented in any method or technology for storage of information such as computer-readable instructions, data structures, program modules, or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Combinations of any of the above are also included within the scope of computer-readable media.

The memory 112 includes computer-storage media in the form of volatile and/or nonvolatile memory. The memory may be removable, nonremovable, or a combination thereof. Exemplary hardware devices include solid-state memory, hard drives, optical-disc drives, etc. The computing device 100 includes one or more processors that read data from various entities such as the memory 112 or the I/O components 120. The presentation component(s) 116 present data indications to a user or other device. Exemplary presentation components include a display device, speaker, printing component, vibrating component, etc.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

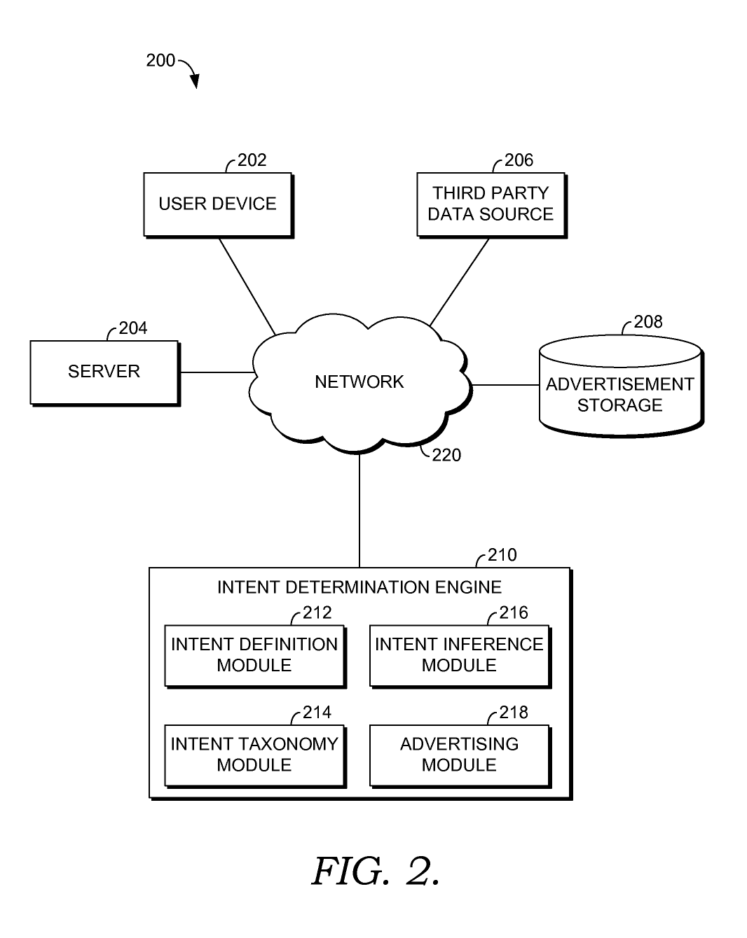

Referring now to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 includes a user device 202, a server 204, a third-party data source 206, an advertisement storage 208, and an intent determination engine 210. Each of the components shown in FIG. 2 may be any type of computing device, such as computing device 100 described with reference to FIG. 1, for example. The components may communicate with each other via a network 220, which may include, without limitation, one or more local area networks (LANs) and/or wide area networks (WANs). Such networking environments are commonplace in offices, enterprise-wide computer networks, intranets, and the Internet. It should be understood that any number of user devices, servers, third-party data sources, advertisement storages, and intent determination engines may be employed within the system 200 within the scope of the present invention. Each may comprise a single device or multiple devices cooperating in a distributed environment. For instance, multiple user devices are typically communicating through the network at any one time. Further, one or more third-party data sources may be utilized in embodiments of the present invention. Additionally, other components not shown may also be included within the system 200.

A user may communicate with the network 220 through a user device, such as user device 202. The user device 202 may be the type of device described in FIG. 1 with respect to the computing device 100. The user device 202, in one embodiment, allows a user to submit a search query on a search website through the network 220. Alternatively, a user may interact with various websites, such as social networking sites. Data from these sites, which may include a log of web pages visited by the user, may be captured from the user device 202 through the network 220.

The third-party data source 206 encompasses various types of data associated with a user, including, for exemplary purposes only, log data (e.g., query logs, page-view logs, web logs, toolbar logs), user profile information (e.g., age, gender, location, interests), and live data, which, in one instance, includes data from various websites, such as social networking sites. This user data from the third-party data source may be used to infer or determine a user's intent. For instance, user data may include various keywords that can be extracted and mapped to a previously generated intent structure, such as a hierarchical tree that represents relationships between topical expressions. In one instance, the keywords in the user data include a subset of the topical expressions, a subset of the actions, and a subset of the attributes. As used herein, topical expressions are one or more alphanumeric strings that represent topics or semantics. For instance, an exemplary topical expression is “Chicago.” Topical expressions are associated with actions, and in some embodiment, attributes, as more fully described herein, to more fully define a topical expression. “Chicago” may refer to the city, the band, or the movie. In order to more fully understand a user's intent, more information about a topical expression is needed. The advertisement storage 208 is a data store that includes advertisements that can be pulled for presentation to the user based on user intent.

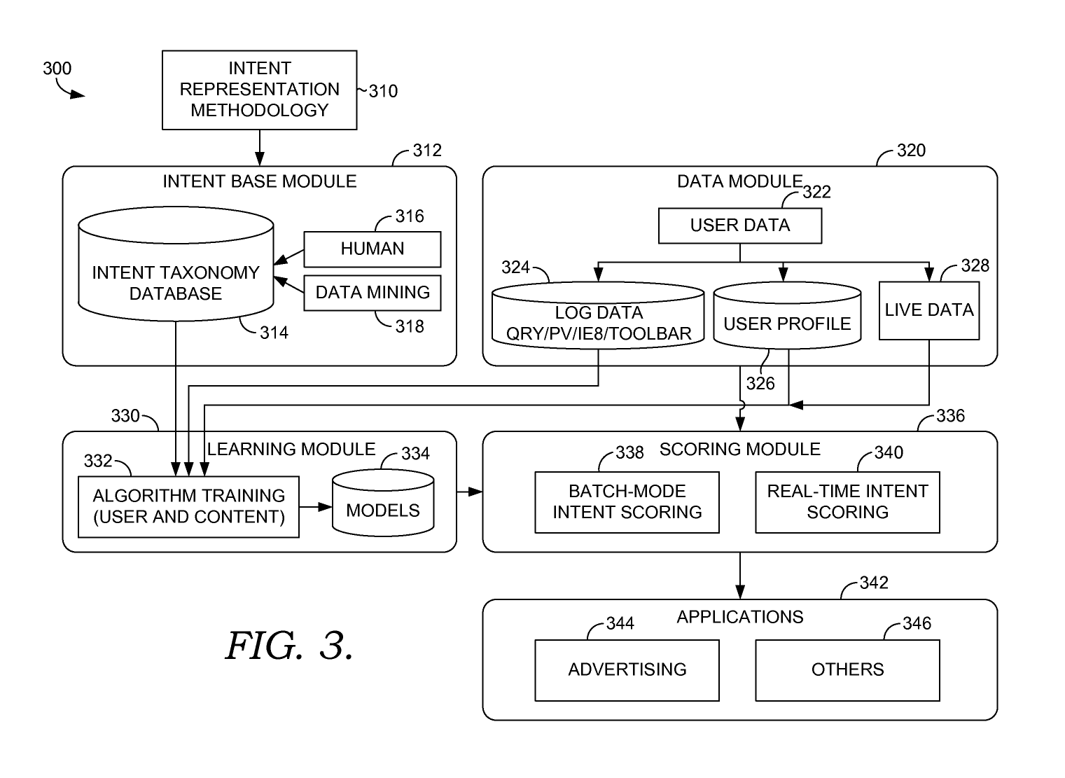

The intent determination engine 210 generally performs a variety of functions, including defining user intent by associating actions, and optionally, attributes with topical expressions, organizing the topical expressions to represent relationships between the topical expressions, and determining the user intent for a particular user using the organized topical expressions and user data received from one or more sources. The intent determination engine 210 includes several individual components or modules. In addition to those now shown in FIG. 2, these modules include an intent definition module 212, an intent taxonomy module 214, an intent inference module 216, and an advertising module 218. The intent definition module 212 is responsible for defining user intent, which can be done in a number of ways. In an embodiment of the present invention, user intent is defined by three aspects, including semantics, preferences, and pragmatics. Semantics are what the intent is about, such as a topic associated with the intent (e.g., topical expression). Using the example above, “Chicago” is an exemplary topic, but can refer to the city, the band, the movie, etc., and in order to more fully understand the user's intent, it is very helpful to understand what the user really wants to know. The second aspect is preferences, such as what the user's preferences are for a certain topic. For instance, for a topical expression of “camera,” preferences may include a color, a brand, a model, etc. Preferences are generally referred to as attributes herein. Lastly, pragmatics include tasks that the user has in mind, such as steps or activities that can be performed to achieve those tasks. Pragmatics are generally referred to as actions herein. Pictorially, user intent can be illustrated in a diagram such as that shown in FIG. 3, which is described more fully below.

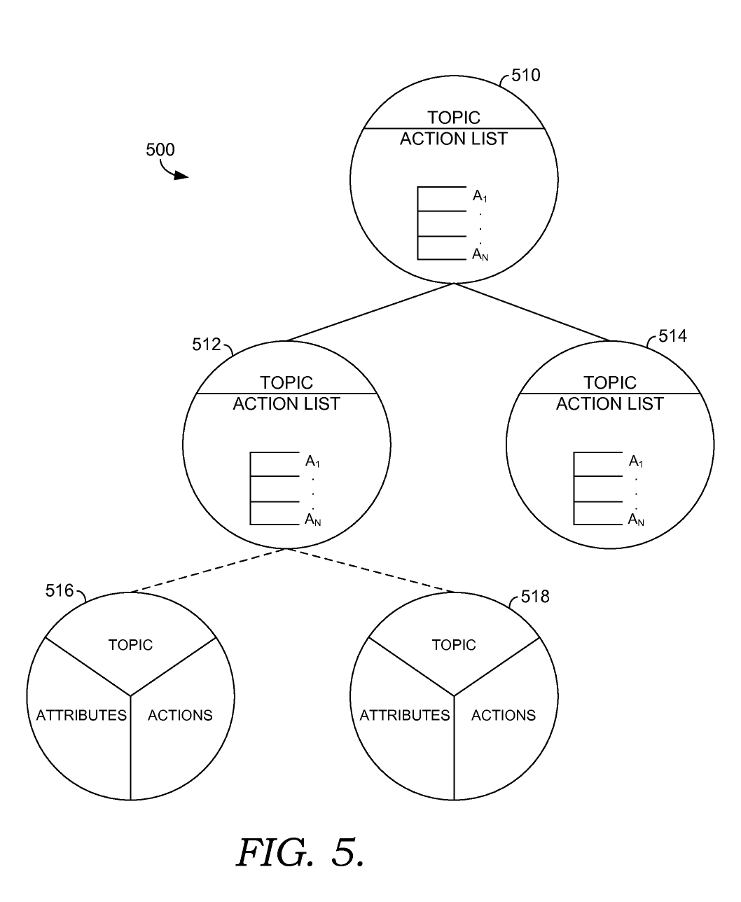

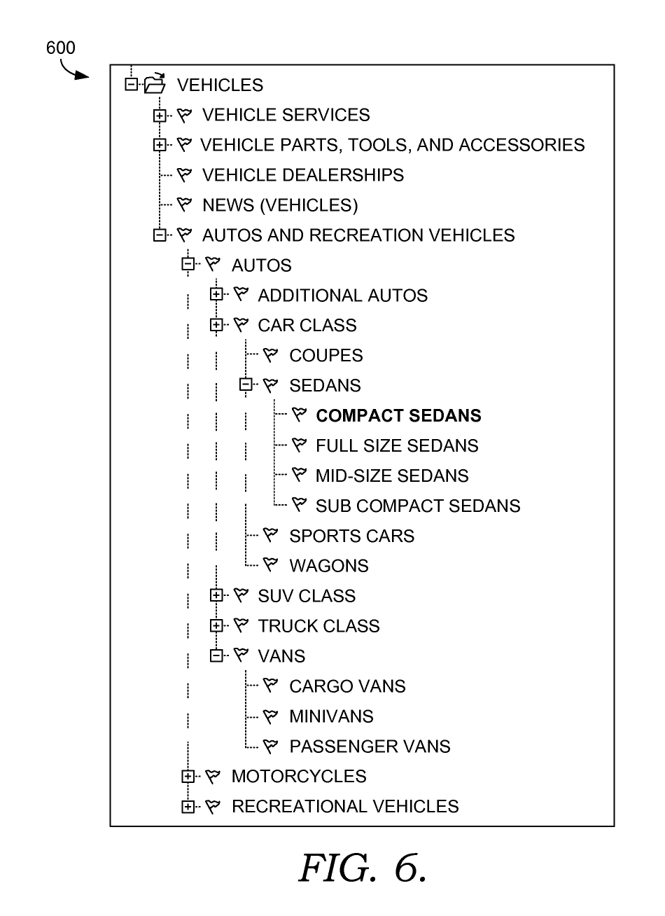

Once user intent is defined by the intent definition module 212, the intent taxonomy module 214 organizes intents so that they can be easily managed, and so that user behaviors can be mapped to the intents. An intent structure is therefore generated that illustrates relationships among various intents, or topical expressions so that chains of intent become apparent. In one embodiment, a taxonomy is built, which organizes topical expressions into a hierarchical tree. Exemplary relationships include “is-a,” “part-of,” and “specific/general.” The topic or topical expression is the carrier of intent. Therefore, an existing topic taxonomy can be followed and proper actions and attributes can be added to each note of a taxonomy or hierarchical tree to expand the topic taxonomy to an intent taxonomy. For exemplary purposes only, “auto” may be a first-level topical expression in a hierarchical tree. At the second level, exemplary topical expressions are “SUV” and “sedan.” At the third level, exemplary topical expressions are “Toyota” and “Honda.” FIG. 5 illustrates an exemplary hierarchical tree of intent taxonomy, as more fully described below. Further, examples of topics, attributes, and actions are illustrated in the tables of FIGS. 6, 7, and 8.

The intent inference module 216 is responsible for determining an actual intent of a particular user. User data is received from one or more sources, including, for example, log data that demonstrates the user's previous behavior (e.g., query logs, page-view logs, web logs, toolbar logs), user profile information (e.g., age, gender, location, interests), and live data, which, in one instance, includes data from various websites, such as social networking sites. Data corresponding to a user's interaction with other websites, for instance, may provide invaluable information as to an intent of the user. In one embodiment, the intent inference module 216 is given an initial intent from a search query submitted by the user. In order to find associated actions and in some embodiment, attributes, user data from one or more of the sources mentioned above is used, and is mapped to the topical expressions and associated attributes and actions in the intent structure that is generated by the intent taxonomy module 214. One or more algorithms may be used, such as an algorithm that models sequential data, like Conditional Random Fields. Specific algorithms are not described here, as various algorithms would be able to function to perform embodiments of the present invention, as described herein.

An exemplary data structure is illustrated below, and may be used to classify the user's intent. Here, the output is the user's intent vector (List <CIntent>, where CIntent is defined as below. In addition to Topic and Action identifications, attributes and values are paired (e.g., model/Toyota, make/Corolla). Prob is a probability as to how likely it is that the user will have the intent as defined, and TimeStamp is a time at which the user may have this intent.

Class CIntent
{
int TopicId;
int ActionId;
List<Dictionary<string, string>> AttributeValuePairs;
float Prob;
DateTime TimeStamp;
}

The advertising module 218 is responsible for selecting and providing advertisements to the user based on the determined or inferred user intent. The advertising module 218 is but one example of a module that provides information based on the determined or inferred user intent. There are various ways that advertising takes place based on intent. In one embodiment, advertisers bid on intent. After a user's intent is inferred (e.g., current intent or projected future intent), advertisers may bid on the intent directly, which can solve the semantic-wise mismatch. In an alternate embodiment, user segments are built based on intent. For example, when a user begins issuing queries about cars, the intent inference module 216 determines what type of cars the user is looking for based on the received user data. If the user is going to have a new baby, for instance (e.g., queries may include “baby names” and “formula”), the user may be interested in an SUV rather than a compact car. Then, advertisers may impress these types of users with their SUV advertisements. At the same time, users are provided more relevant advertisements, which improves their overall user experience. Advertisers can browse through intent taxonomies to choose intents for which they will provide advertisements, or can put forward certain intents that they want to cover and these can be added to the intent taxonomy.

As mentioned, other modules not shown in FIG. 2 may be used to provide other information to a user based on user intent. For instance, personalized service can be provided on search and news websites. For example, if the user types in a query “buy a car,” using the other modules described above, the topic may be determined to be “car” and an action may be determined to be “buy.” The user's preferences (e.g., attributes), if included, may be determined from other sources. For instance, a user may have written on a message board that he is looking to buy a BMW. Search results may then be biased to provide more information about BMW car deals for the user. Similarly, knowing the user intent can assist in providing better web page suggestions for the user on a news or other informational website that can be customized. For instance, news articles pertaining to the determined user intent may be provided in addition to or in place of news articles that are not on point.

Yet another module that may be used to provide information to a user based on the user intent may provide, in addition to or in place of search results, a series of steps that the user can follow to complete a task related to the user intent. For instance, if it is determined that the user is looking to purchase a house in New York, various steps may include links to real estate websites, links to home insurance websites, etc. These steps may be ordered in such a way as to direct the user through multiple steps that can be followed in a sequential manner.

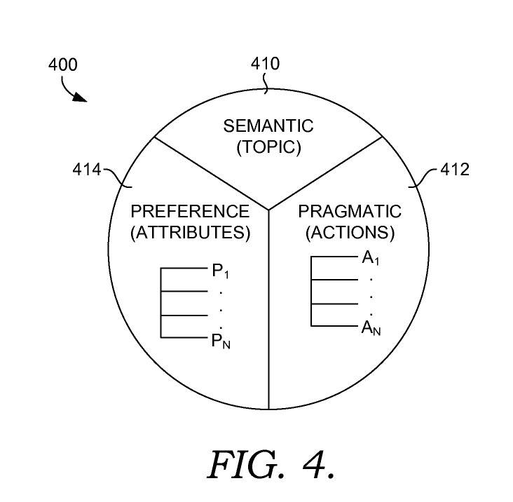

FIG. 3 is a block diagram of an exemplary system 300 for advertising based on a defined user intent, in accordance with embodiments of the present invention. Initially, while many of the components of FIG. 3 have already been described here, they are shown here to illustrate how the data flows to and from various components. The intent representation methodology 310 defines user intent, as described above with reference to the intent definition module 212 of FIG. 2. To define user intent, semantics, preferences, and pragmatics are identified and associated with one another. Semantics are topical expressions that indicate a topic of interest to the user. Preferences are attributes that are associated with the topical expression. Pragmatics are actions, such as steps that can be taken that correspond to the topical expression. Diagrams, such as that shown in FIG. 4, are generated and are passed to an intent base module 312 for further processing.

The intent base module 312 includes an intent taxonomy database 314, which receives data from either human sources 316 or data mining 318. The intent base module 312 as a whole generates intent structures, such as taxonomies (e.g., hierarchical structures) that illustrate relationships between various topical expressions. Data, such as from human sources 316 or data mining 318 is used to create these intent structures. For instance, a human 316 may input a topical expression, in addition to actions and optionally, attributes that are associated with that topical expression. Alternatively, keywords may be extracted from data mining 318 and are categorized as topical expressions, attributes, or actions. The keywords are then associated with one another to form diagrams such as that shown in FIG. 4, and eventually, intent structures such as the intent structure illustrated in FIG. 5, as more fully described below.

Data 320 may be received as signals from various sources. The type of data includes, for exemplary purposes only, third-party data 322, such as log data 324 (e.g., query logs, page-view logs, web logs, toolbar logs), user profile information 326 (e.g., age, gender, location, interests), and live data 328, which, in one instance, includes data from various websites, such as social networking sites. As shown, the data is fed to a learning tool 330 that includes an algorithm training component 332 that stores models in the model database 334. As previously described, various algorithms may be used to determine user intent using the intent structures generated by the intent taxonomy 314 and the received user data 322. For instance, keywords extracted from the user data may be mapped to taxonomies received from the intent taxonomy database 314. This user data effectively trains the algorithms as to what to look for when extracting keywords from the user data. Specific taxonomies for a particular user are stored in the model database 334.

The scoring module 336 either operates to provide scores for intents in batch-mode by the batch-mode intent scoring module 338, or provides scores in real-time by the real-time intent scoring module 340. The batch-mode scoring may be performed prior to the request for information, such as advertisements, personalization, search results, etc. To the contrary, scoring can be performed after a request for this type of information. So, a user may enter a query into a search page, and intents that are used to select information to present to the user can be scored at that time so that the most relevant advertisements or other such information can be provided to the user.

Once user intent has been determined for a particular user, information can be provided to that user based on the user intent. As mentioned above, advertisements are just one form of information that can be provided to a user. Applications 342 are stored, including an advertising module 344. Other applications 346 may also be stored here. The advertising module 344 is responsible for identifying which advertisements to provide to the user. This may involve, in one embodiment, requesting that advertisers bid on intents using the intent structures. Or, advertisers may be notified as to a certain intent that is associated with advertisements provided by that advertiser, and the advertiser may proceed to submit advertisements that are relevant to that user intent. While not shown here, other applications 346 may be used to provide search results, sets of actions related to a user intent, or personalization on a web page, all based on a determined user intent.

The following is an example that illustrates how each component and step shown in FIG. 3 is used to determine user intent. As mentioned, the user intent representation approach follows three dimensions or aspects, including topic, action, and in some embodiments, attributes. An intent taxonomy is defined with this representation approach to define the intent space of interest. Specifically, for one node in the intent taxonomy, the topic may be, for example, “compact sedans.” The actions may include “buy,” “sell,” “repair,” and “review.” The attributes may include “model,” “color,” “fuel type,” and so on. In one example, a user has submitted queries in the past such as “car price” and “car deals” to a particular search engine and has visited various web pages about autos, and has written information on social networking sites such as “m3 looks great” and “my next car should be a BMW M3. Intent inference algorithms can determine that the user's intent is to buy a compact sedan, with the model being M3. This is done by analyzing all of the user information received using the intent taxonomies. Then, this user intent can be leveraged to improve advertising and search results. For advertising, an advertising agent of BMW, for instance, can be contacted and told about specific users who are specifically looking for a certain BMW car, and BMW-specific advertisements are provided to that user. For search, when the user types “car deals” the next time, search results can be biased to show more deals about “M3” so that the user has a better chance of finding the right and relevant information.

Turning now to FIG. 4, a diagram 400 is shown illustrating three aspects used to define user intent, in accordance with an embodiment of the present invention. The three aspects described above, namely semantics, preferences, and pragmatics, are orthogonal, as they define a complete picture, when taken together, about what a user wants to do and how to do it. This is illustrated in FIG. 4. The semantic portion 410 of the diagram is the portion that lists a topical expression. For instance, the topical expression may be “Chicago,” “Auto,” “Camera,” etc. The pragmatic portion 412 of the diagram lists one or more actions that are associated with the topical expression. For instance, if the topical expression is “Auto,” exemplary actions are “buy,” “sell,” “repair,” “reviews,” etc. The preference portion 414 of the diagram lists one or more attributes that are associated with the topical expression. For instance, using the example above of a topical expression of “Auto,” exemplary attributes include “manufacturer,” “model,” “cost level,” etc. As previously mentioned attributes are associated with the topical expression in some embodiments but in other embodiments, are not associated with the topical expression.

Referring to FIG. 5, a hierarchical tree 500 is shown that is used to define intent taxonomy, in accordance with an embodiment of the present invention. Each topical expression is assigned to a node, including nodes 510, 512, 514, 516, and 518. The internal nodes 510, 512, and 514, or nonleaf nodes, include the topical expression and associated actions, as this is specific enough for the more general topics. For leaf nodes, however, such as nodes 516 and 518, attributes are also listed. Other embodiments may include all of topical expressions, actions, and attributes on each node. As mentioned, intent structures illustrate relationships between topical expressions. For example, “Auto” may be the topical expression at the top of the hierarchical structure, such as for node 510. Nodes 512 and 514 may include topical expressions such as “SUV” and “sedan,” while nodes 516 and 518 may include topical expressions such as “Toyota” and “Honda.” In one embodiment, topical expressions nearer to the top of the hierarchical structure are generally broader than those nearer to the bottom.

FIG. 6 is a table 600 illustrating a hierarchical structure of topics, in accordance with an embodiment of the present invention. The topical expressions shown in FIG. 6 represent a specific example of a hierarchical structure of topics, and in no way is FIG. 6 meant to limit the scope of the present invention. As an embodiment of the present invention, various topical expressions are illustrated in a hierarchical structure, with “vehicles” being the uppermost topical expression that is visible. Directly beneath “vehicles” are several topical expressions that are slightly narrower in subject matter than vehicles. These include “vehicle services,” “vehicle parts, tools, and accessories,” “vehicle dealerships,” “news (vehicles),” and “autos and recreation vehicles.” As shown by the plus sign to the left of “vehicle services” and “vehicle parts, tools, and accessories,” these topical expressions can be expanded and contain multiple, narrower topical expressions beneath them. “Autos and Recreation Vehicles” is shown with a minus sign to its left, indicating that the topical expressions are shown below, Here, “autos,” “motorcycles,” and “recreational vehicles” are the three topical expressions beneath “autos and recreation vehicles.” Generally, this indicates that these three lower-level topical expressions are narrower than the higher-level topical expression, and also indicates that each of the lower-level topical expressions are separately related to the higher-level topical expression in some way. Further examples of lower-level topical expressions can be seen in FIG. 6.

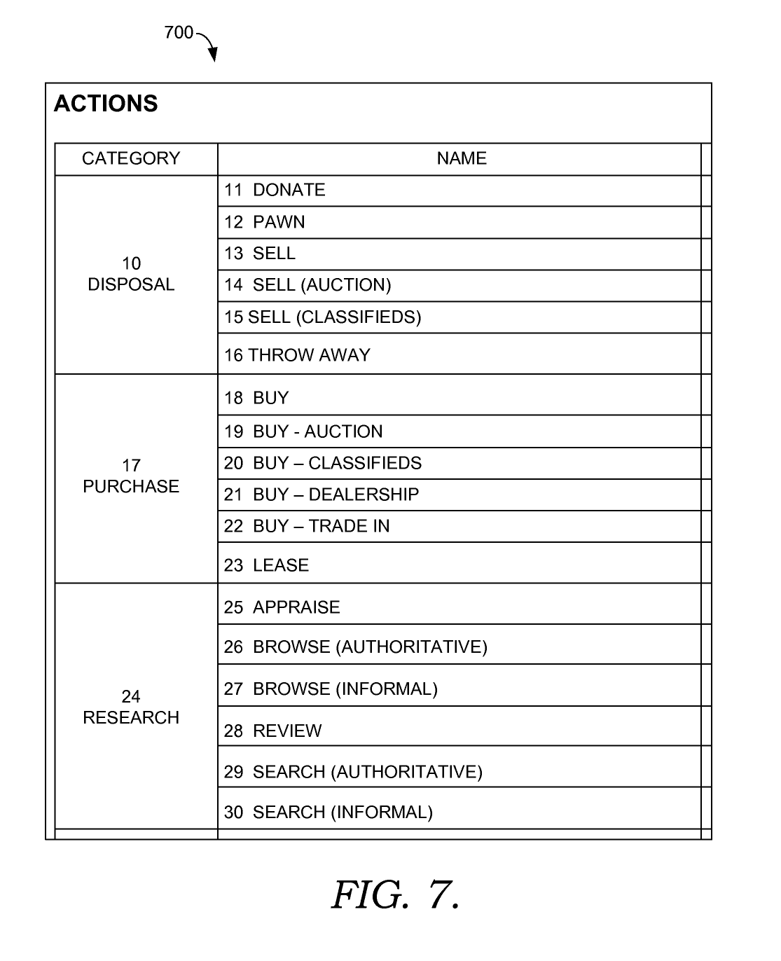

FIG. 7 is a table 700 listing exemplary actions associated with a particular topic, in accordance with an embodiment of the present invention. Just as exemplary topical expressions are listed in FIG. 6, exemplary actions are listed in FIG. 7. In particular, these actions relate to “compact sedans” shown in bold in FIG. 6. Exemplary actions include disposal, purchase, and research. As such, a user may want to get rid of this car, whether this be by donating, pawning, selling, selling by auction, selling by classifieds, throwing away, etc. Further, a user may want to purchase a compact sedan. Purchasing may include buying, buying by auction, buying by classified, buying from a dealership, trading in another car to purchase the compact sedan, leasing, etc. Moreover, a user may want to perform research on a compact sedan. Research may include, for example, getting the car appraised, authoritative browsing, informal browsing, viewing reviews of the car, authoritative searching, informal searching, etc.

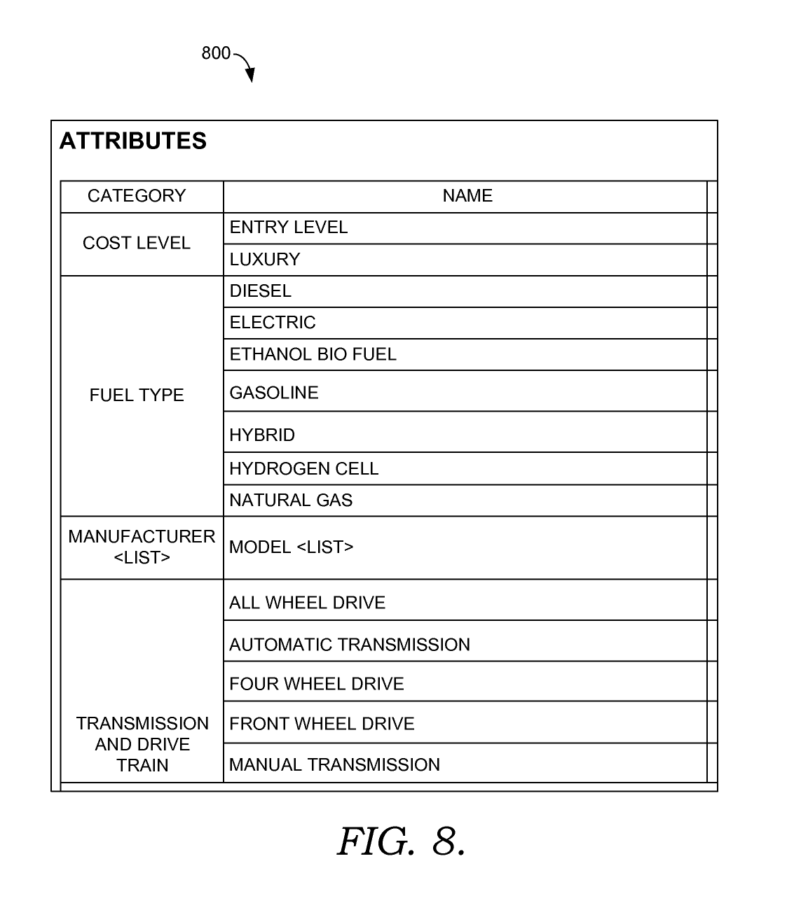

Turning to FIG. 8, a table 800 is illustrated listing exemplary attributes associated with a particular topic, in accordance with an embodiment of the present invention. Like the table 700 shown in FIG. 7, the table 800 shown in FIG. 8 lists various words that are associated with a particular topical expression, such as a “compact sedan.” Here, the words are attributes. Exemplary categories include “cost level,” “fuel type,” “manufacturer,” and “transmission and drive train.” For each of these categories, one or more values are also listed such that attribute/value pairs can be associated when user intent is inferred. These values are listed in FIG. 8. Again, each of the categories listed above and shown in FIG. 8 can somehow be associated with the exemplary topical expression, “compact sedan.”

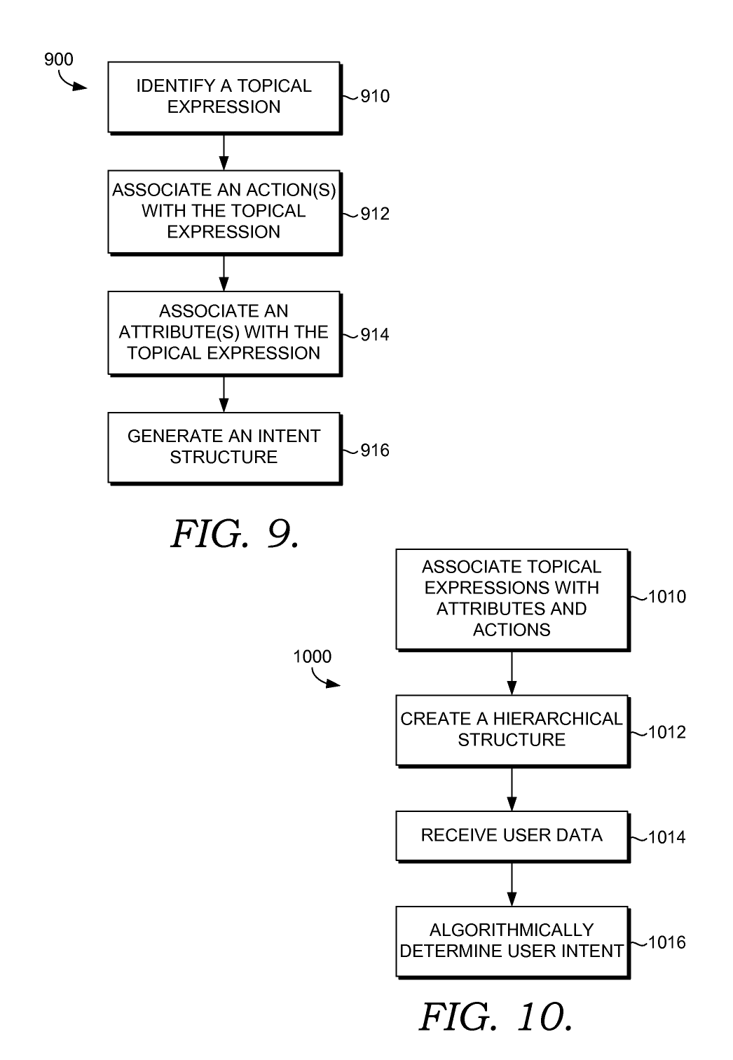

FIG. 9 is a flow diagram of a method 900 for defining user intent, in accordance with embodiments of the present invention. Initially, at step 910, a topical expression is identified. As previously described, a topical expression is one or more alphanumeric strings that indicate a topic or subject matter of interest to the user. In one embodiment, the topical expression is identified from a search query submitted by a user. In other embodiments, topical expressions are identified from other data sources, such as data logs, user profiles, websites (e.g., social networking sites), or the like. At least one action is associated with the topical expression at step 912. The action indicates a step to be performed to achieve a task corresponding to the topical expression. At step 914, at least one attribute is associated with the topical expression. An intent structure is generated at step 916. The intent structure indicates a relationship between the topical expression and one or more other topical expressions. An exemplary intent structure is illustrated in FIG. 5. This type of intent structure is a hierarchical tree, but this is just one type of intent structure that can be generated.

Further, user data may be received from one or more sources, including a social networking website, log data, or a user profile. The user profile, for instance, may indicate an age, gender, and interest of a particular user. Utilizing the user data, user intent is inferred or determined for a particular user. This determination, in one embodiment, is made by an algorithm. Once user intent is determined, information, such as advertisements, can be provided to the user based on the user intent. Other types of information provided based on user intent may include personalized information displayed on a web page, such as a news web page. Further, search results may be returned to the user based on the determined user intent. Even further, one or more steps that are recommended to the user to accomplish a task corresponding to the topical expression may be provided to the user.

Referring to FIG. 10, a flow diagram is shown of a method 1000 for representing user intent, in accordance with embodiments of the present invention. At step 1010, each of a plurality of topical expressions are associated with attributes and actions. At step 1012, a hierarchical structure is generated that represents relationships between the plurality of topical expressions. User data is received at step 1014. The user data may be received from one or more sources. Further, at step 1016, user intent is algorithmically determined. For instance, user intent may be determined by identifying keywords in the user data that correspond to topical expressions, attributes, and actions in the hierarchical structure. Once user intent is determined, advertisements or other information can be presented to the user based on the user intent. Alternatively, a search query may be input by a user, and search results can be selected and presented to the user on a search results page based on the search query input and user data.

As can be understood, embodiments of the present invention provide for defining user intent. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media storing computer-useable instructions that, when used by one or more computing devices, cause the one or more computing devices to perform a method comprising:
identifying a topical expression;
associating at least one action with the topical expression, wherein the at least one action indicates a step to be performed to achieve a task corresponding to the topical expression; and
generating an intent structure that indicates a relationship between the topical expression and one or more other topical expressions.

2. The one or more computer-readable media of claim 1, further comprising associating at least one attribute with the topical expression.

3. The one or more computer-readable media of claim 2, further comprising receiving user data from one or more sources, wherein the user data is received from at least one of a social networking website, log data, or a user profile.

4. The one or more computer-readable media of claim 2, further comprising utilizing the user data, determining user intent corresponding to a particular user.

5. The one or more computer-readable media of claim 1, wherein the topical expression is identified from at least a search query submitted by a user.

6. The one or more computer-readable media of claim 1, wherein the intent structure is a hierarchical tree.

7. The one or more computer-readable media of claim 4, further comprising providing one or more advertisements to the user based on the determined user intent.

8. The one or more computer-readable media of claim 7, wherein the user intent is determined by an algorithm.

9. The one or more computer-readable media of claim 4, further comprising personalizing a web page based on the user intent.

10. The one or more computer-readable media of claim 4, further comprising providing one or more search results on a search results page based on the user intent.

11. The one or more computer-readable media of claim 4, further comprising providing one or more steps that are recommended to the user to accomplish the task corresponding to the topical expression.

12. A search result modification system, comprising:
a computing device associated with one or more processors and one or more computer-readable storage media;
a data store coupled with the computing device; and
an intent determination engine that defines user intent by associating actions and attributes with topical expressions, organizes the topical expressions to represent relationships between the topical expressions, and determines the user intent for a particular user using the organized topical expressions and user data received from one or more sources.

13. The system of claim 12, wherein the intent determination engine algorithmically determines the user intent for the particular user by identifying keywords in the user data that correspond to the topical expressions, the actions, and the attributes in the hierarchical structure.

14. The system of claim 13, wherein the keywords in the user data include a subset of the topical expressions, a subset of the actions, and a subset of the attributes.

15. The system of claim 14, wherein the subset of the attributes indicates user preferences corresponding to a particular topical expression.

16. The system of claim 12, wherein the intent determination engine communicates the user intent to an advertisement delivery engine that selects advertisements to provide to the user based on the user's intent.

17. The system of claim 12, wherein the subset of the actions indicates steps to be performed to achieve a task corresponding to a particular topical expression.

18. One or more computer-readable media storing computer-useable instructions that, when used by one or more computing devices, cause the one or more computing devices to perform a method comprising:
associating each of a plurality of topical expressions with at least one attribute and at least one action;
generating a hierarchical structure that represents relationships between the plurality of topical expressions;
receiving user data from one or more sources; and
algorithmically determining user intent by identifying keywords in the user data that correspond to the plurality of topical expressions, the at least one attribute, and the at least one action in the hierarchical structure.

19. The one or more computer-readable media of claim 18, further comprising presenting one or more advertisements to a user based on the determined user intent.

20. The one or more computer-readable media of claim 18, further comprising:
receiving a search query input from a user; and
presenting search results to a user on a search results page based on the search query input and the user data.
